(19) United States
(12) Patent Application Publication
(10) Pub. No.: US 2004/0052601 A1
(43) Pub. Date: Mar. 18, 2004

(54) Spindle head for a machine tool

(75) Inventors: Franz-Xaver Bernhard, Gosheim (DE); Tobias Schworer, Konigsheim (DE)

Correspondence Address: BROWDY AND NEIMARK, P.L.L.C., 624 NINTH STREET, NW, SUITE 300, WASHINGTON, DC, 20001-5303, US

(73) Assignee: Maschinenfabrik Berthold Hermle AG, Gosheim (DE)

(21) Appl. No.: 10/649,774

(22) Filed: Aug. 28, 2003

(30) Foreign Application Priority Data
Sep. 13, 2002 (EP) 02 020 612.4

(51) Int. Cl. B23C 1/00

(52) U.S. Cl. 409/231

(57) ABSTRACT

A spindle head for a machine tool with a motor-spindle unit arranged on or integrated in the spindle head has a drive motor whose shaft is in the form of a spindle to hold tools, workpieces or workpiece blanks. The drive motor of the motor-spindle unit is able to be slid in the axial direction in the spindle housing, a compressible means being provided for impeding axial displacement of the drive motor into the spindle housing and by such compressible means the drive motor is held as far as a predetermined axial force level in its predetermined working position. Accordingly protection against collisions may be provided in a simple and economic manner also for spindle heads whose drive motor is integrated in the spindle housing.

### BACKGROUND OF THE INVENTION

The invention relates to a spindle head for a machine tool with a drive motor comprising a motor-spindle unit arranged in the spindle head whose motor shaft is adapted to serve as a spindle to mount tools, workpieces or workpiece blanks.

### THE PRIOR ART

Such spindle heads, in the case of which the drive motor is integrated in the spindle housing are for instance disclosed in the German patent publication 10,027,750 A1, the European patent publication 0 780 192B1, the German patent publication (utility model) 20,015,568 U1 and the German patent publication 19,937,447A1. The advantages of this principle of construction is on the one hand the resulting extremely short motor spindle and on the other hand the extremely simple and economic design. The disadvantage of this manner of construction is that any collision in the axial direction involving damage means that the entire unit must be replaced.

The European patent publication 0 755 750 A1 discloses a spindle head in the case of which the drive motor and the spindle constitute two separate assemblies, which are united by means of an axially sliding coupling. Following a collision in the axial direction in principle it is therefore only necessary to replace the spindle head. A disadvantage in this design is the relatively long motor-spindle and owing to the separate supports for the drive motor and the spindle there is a relatively complex construction. Although for the protection of the separate spindle in the case of axial collisions there are compressible sleeves, they however permit only displacement of the spindle directly mounted in the spindle head housing in relation to the latter, whereas the drive motor is fixed permanently and firmly in the spindle head housing.

### SHORT SUMMARY OF THE INVENTION

One object of the present invention is to provide for protection against collisions in the axial direction for spindle heads having motor-spindle units as well which are integrated in the spindle housing.

In accordance with the invention this object is to be achieved by the features that the drive motor of the motor-spindle unit is able to slide in the axial direction in the spindle housing, and a compressible means is provided for resisting axial displacement of the drive motor into the spindle housing so that such compressible means holds the drive motor in its intended working position up to a predetermined axial force level.

The advantages of the invention reside more particularly in that the entire integrated motor-spindle unit, comprising the spindle and the drive motor, is protected by a compressible means in the case of collisions in the axial direction. The advantages of the integrated motor-spindle unit may consequently be combined with the advantages of a protective compressible means. Furthermore, the economic design with a small overall length may be effectively protected in the case of collisions in the axial direction so that the danger of resulting damage is practically completely prevented.

The features recited in the dependent claims represent advantageous further developments and improvements in the spindle head claimed in claim 1.

As a compressible means it is more particularly preferred to employ at least one spacing element deforming when subjected to a predetermined axial force or a spring element.

The compressible means may in an advantageous fashion be arranged between axially opposite faces on the spindle housing and the drive motor, which when the predetermined axial force is reached move together with a deformation of the compressible means. In this respect the compressible means may be advantageously in the form of an annular element fitting around the drive motor.

In accordance with an alternative design at least one axially aligned holding screw is provided to hold the motor-spindle unit in the axial direction in the spindle housing, the head of the screw acting by way of the compressible means. In this case several holding screws may be provided distributed about the periphery of the drive motor, each holding screw being provided with a compressible sleeve or the holding screws acting by way of an annular element surrounding the drive motor.

In order to be able to react to deformation of the compressible element in a suitable manner, it is an advantage to provide a switching means responsive to such a deformation. This response is preferably caused by sensor means for the detection of a relative axial movement between the drive motor and the spindle housing.

In accordance with an advantageous design the drive motor of the motor-spindle unit is provided with a peripheral groove with a sensor element, running on the spindle housing, fitting into it, a relative displacement, produced by axial displacement of the drive motor, of the sensor element being linked with the switching means for the operation of the latter.

The switching means is preferably designed for switching off, for changing the direction of spindle feed or for switching off the entire machine tool in order to prevent damage.

Further advantageous developments and convenient forms of the invention will be understood from the following detailed descriptive disclosure of three embodiments thereof in conjunction with the accompanying drawings.

### LIST OF THE SEVERAL VIEWS OF THE FIGURES

FIG. 1 is a longitudinal section to represent a spindle head for a machine tool as a first embodiment.

FIG. 2 shows a spindle head in a similar manner of representation as a second embodiment of the invention.

FIG. 3 shows a spindle head in a similar fashion of representation as a third embodiment of the invention.

### DETAILED ACCOUNT OF WORKING EMBODIMENTS OF THE INVENTION

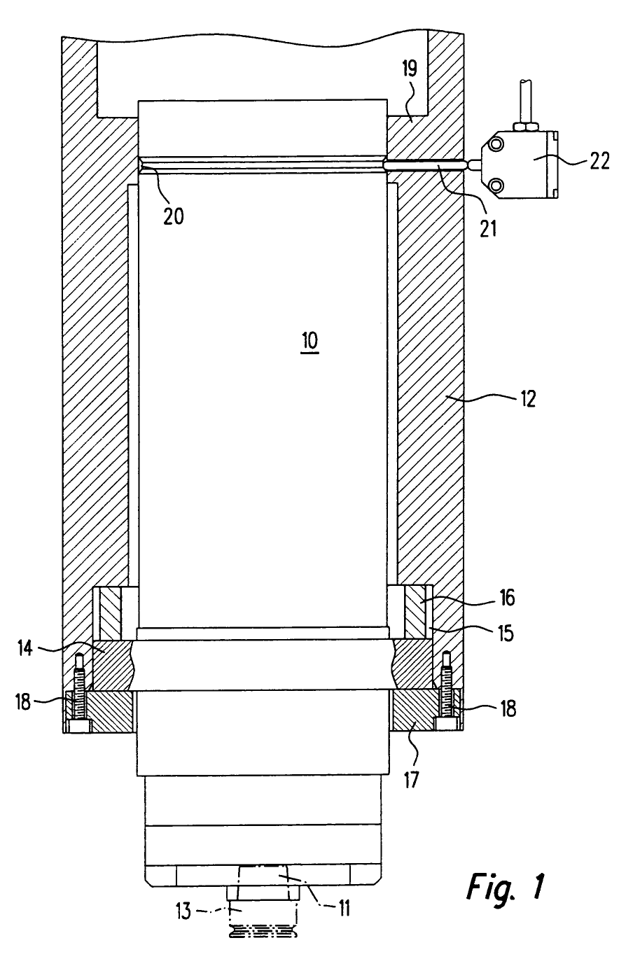

In the case of the first embodiment of the invention illustrated in FIG. 1 a drive motor 10 for a spindle 11 is supported in a longitudinally displaceable manner in a cylindrical spindle housing 12, such spindle 11 serving to mount a drilling or milling tool, a workpiece or a workpiece blank, such longitudinal displacement being vertical in the case of a vertical spindle. The shaft of the of the drive motor 10 is here designed in the form of a spindle, that is to say the spindle 11 is integrated in the drive motor 10 with the formation of a motor-spindle unit, as is the case with the initially mentioned prior art. In its region adjacent to the tool or workpiece receiving means 13 of the spindle 11 the drive motor 10 possesses a peripheral annular flange 14, fitting into the a corresponding annular groove 15 on the inner side of the spindle housing 12. The axial width of the annular groove 15 is substantially larger than the axial diameter of the annular flange 14 so that in principle an axial displacement of the drive motor 10 in the spindle housing 12 would be possible. During normal operation this displacement is prevented by a compressible means, which is in the form of an annular element 16 on an annular disk 17 at the end of the spindle housing, such annular disk 17 being mounted by means of holding screws 18 on the end side (facing the tool) of the spindle housing 12. The drive motor 10 is able to be slid through the opening in the annular disk 17.

The end region, remote from the tool, of the drive motor 10 is guided by an annular projection 19, extending radially inward, on the spindle housing 12. In this region at its periphery the drive motor 10 possesses an annular groove 20, into which a rod-like sensor element 21 fits in the radial direction. At its opposite end region this sensor element 21 acts on a switch 22. When the drive motor 10 is moved in relation to the spindle housing 12 axially, the rod-like sensor element 21 is moved from the annular groove 20 radially outward and operates the switch 22.

The manner of operation of the collision preventing means illustrated is such that in the case of collisions in the axial direction, be it owing to axial displacement of the spindle head or be it owing to axial displacement of the workpiece, a force is exerted on the spindle 11 and accordingly on the drive motor 10. As from a predetermined force level the annular element 16 designed in the form of a compressible means is compressed so that the spindle 11 and accordingly the drive motor 10 may slide into the spindle housing 12. Therefore the switch 22 is operated in the fashion already described, which accordingly either turns off the feed of the workpiece or of the spindle head or reverses same for movement in the opposite direction. As an alternative the entire machine tool could be turned off.

Instead of an annular element 16 as a compressible means it would naturally also be possible for differently designed compressible means to be arranged in the gap between the annular flange of the dive motor 10 and the oppositely placed wall region of the annular groove 15. For instance, individual compressible elements or compressible sleeves or compressible springs could be arranged there.

Instead of the rod-like sensor element 21 and of the switch 22 other sensor means may be employed for the detection of relative movement between the drive motor 10 and the spindle housing 12. For example, such sensor means may also be adapted to be responsive to deformation of the compressible means or as other mechanical, optical, magnetic or electromagnetic sensors.

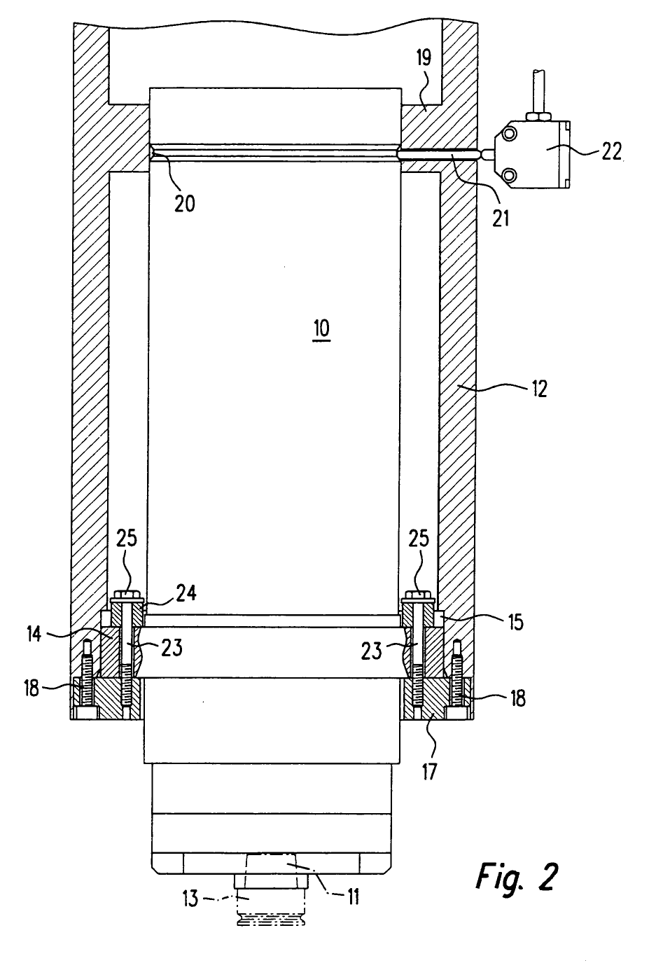

The second embodiment depicted in FIG. 2 possesses a analogous basic design. Identical or similar components are provided with the same reference numerals and are not described all over again. In the case of this working example the annular flange 14 on the drive motor 10 is held in position by means of holding screws 23 on the annular disk 17 from the inside. A circular ring-like compressible means 24 is arranged between the heads 25 of the holding screws 23 and the annular flange 14, that is to say the screw heads 25 bear by way of the compressible means 24 on the annular flange 14. Instead of a circular compressible means 24 a sleeve-like compressible means may be provided for each holding screw 23, such means having the holding screws 23 extending through it and having the screw heads 25 bearing against it. The circular compressible means 24 or, respectively, the individual sleeve-like compressible means may be designed in the form of irreversibly or plastically deforming elements or a spring, reslieint element, for example belleville washers. This also applies for the first embodiment.

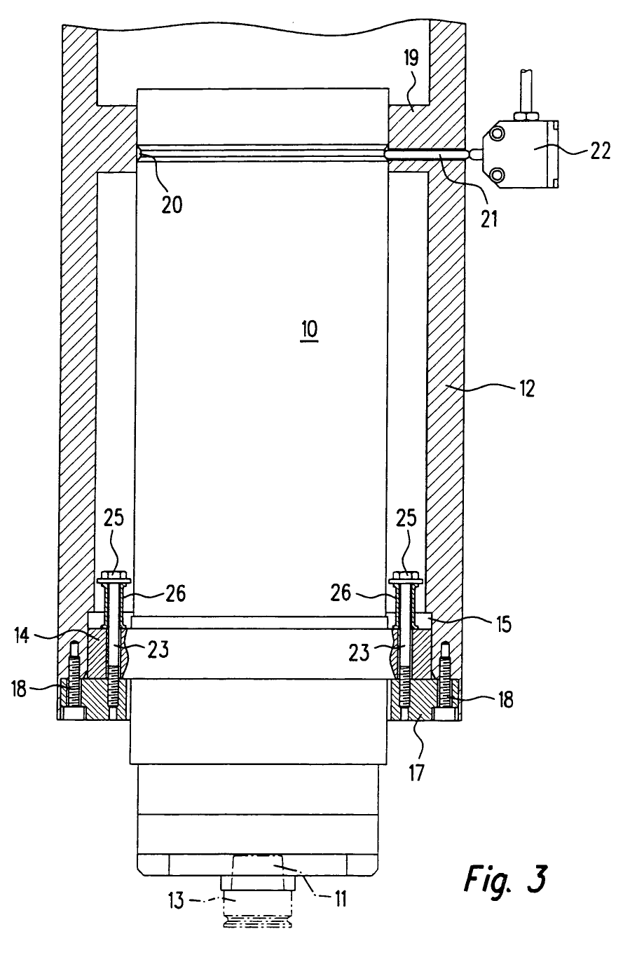

The third embodiment of the invention illustrated in FIG. 3 is substantially similar to the second embodiment. Instead of the circular compressible means 24 in this case each holding screw 23 provided with a tubular compressible means 26. The holding screws 23 extend through these tubular compressible means 26, the screw heads 25 again bearing against it. In this case as well the manner of functioning is similar to that of the previous embodiments of the invention.

As a modification of the embodiments illustrated it is naturally possible for the compressible means to be arranged in the rear region remote from the tool or workpiece receiving means or in the middle region of the motor-spindle unit.

1. A spindle head for a machine tool comprising a motor-spindle unit arranged in the spindle head which a drive motor whose motor shaft is adapted to serve as a spindle to mount tools, workpieces or workpiece blanks, wherein the drive motor of the motor-spindle unit is able to slide in the axial direction in the spindle housing, and a compressible means is provided for resisting axial displacement of the drive motor into the spindle housing so that such compressible means holds the drive motor in its intended working position up to a predetermined axial force level.

2. The spindle head as set forth in claim 1, comprising as a compressible means at least one spacing element or spring element adapted to deform when predetermined axial force level is reached.

3. The spindle head as set forth in claim 2, wherein the compressible means is arranged between axially opposite faces of the spindle housing and of the drive motor of the motor-spindle unit.

4. The spindle head as set forth in claim 3, wherein the compressible means is constituted by an annular element encircling the drive motor.

5. The spindle head as set forth in claim 2, comprising at least one axially aligned holding screw holding the drive motor in the axial direction on the spindle housing, the head of such screw bearing against the compressible means.

6. The spindle head as set forth in claim 5, comprising a plurality of holding screws distributed about the periphery of the drive motor, each holding screw being provided with a compressible sleeve or said holding screws bearing against an intermediate annular element surrounding the drive motor.

7. The spindle head as set forth in claim 1, comprising a switching means responsive on deformation of the compressible means.

8. The spindle head as set forth in claim 7, comprising sensor means adapted to detect a relative axial movement between the drive motor and the spindle housing, such sensor means being adapted to cause operation of the switching means.

9. The spindle head as set forth in claim 8, wherein the drive motor is provided with a peripheral groove with a sensor element fitting into it, such sensor element being guided on the spindle housing, a radial displacement of the sensor element, caused by axial displacement of the drive motor, being linked with same for causing operation of the switching means.

10. The spindle head as set forth in claim 7, wherein the switching means is designed to switch off or reverse the spindle feed or the tool feed or to switch off the entire machine tool.
